(19) United States
(12) Patent Application Publication
(10) Pub. No.: US 2014/0259028 A1
(43) Pub. Date: Sep. 11, 2014

(54) MECHANISM FOR ESTABLISHING TEMPORARY BACKGROUND COMMUNICATION BETWEEN APPLICATIONS

(71) Applicant: GOOGLE INC., Mountain View, CA (US)

(72) Inventors: Scott Roy Atwood, Campbell, CA (US); Prakash Hariramani, San Francisco, CA (US)

(73) Assignee: GOOGLE INC., Mountain View, CA (US)

(21) Appl. No.: 14/140,884

(22) Filed: Dec. 26, 2013

Related U.S. Application Data
(60) Provisional application No. 61/773,122, filed on Mar. 5, 2013.

(51) Int. Cl. G06F 9/54

(52) U.S. Cl. CPC G06F 9/546
USPC 719/313

(57) ABSTRACT

A client application operating in the foreground on a computing device establishes a temporary background communication with a second application by requesting the operating system launch a URL associated with the second application. The request to launch the URL includes a named pasteboard. The second application records the named pasteboard and opens a monitoring process to monitor the pasteboard. The first and second application may communicate by reading and writing information to the named pasteboard while the first application continues to operate in the foreground.

### CROSS-REFERENCE TO RELATED APPLICATIONS

This patent application claims priority to U.S. Provisional Patent Application No. 61/773,122 filed Mar. 5, 2013 and entitled “A Mechanism for Establishing Temporary Background Communication Between Applications.” The entire disclosure of the above-identified priority application is hereby fully incorporated herein by reference.

### TECHNICAL FIELD

The present disclosure relates to methods and systems for establishing temporary background communication between unrelated applications executing on a computing device.

### BACKGROUND

Merchants and application developers create service application that allow users to initiate service requests. Depending on the type of service that a service application provides, the service application may need to communicate with other service applications to create a service request. Also, secure communication between service application is important for communication of sensitive data, such as payment information or personal identification information. Currently, some operating systems are constrained in that only a single application can operating in the foreground of the operating environment and simultaneous communication between two applications is prevented.

### SUMMARY

In certain example embodiments described herein, a method to establish temporary background communication between two applications comprises communicating, by a client application executing on a computer device, a request to launch a service application to the computer device operating system, launching, by the operating system, the service application by opening a launch URL include in the launch request, recording, by the service application, the location of a named pasteboard included in the launch URL, establishing, by the service application, a background monitoring task to monitor the named pasteboard for data requests from the client application, and returning, by the operating system, control to the client application.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for establishing temporary background communication between unrelated applications, in accordance with certain example embodiments.

FIG. 2 is a block flow diagram depicting a method to establish temporary background communication between unrelated applications, in accordance with certain example embodiments.

FIG. 3 is a block diagram depicting a computing machine and a module, in accordance with certain example embodiments.

### DETAILED DESCRIPTION OF THE EXAMPLE EMBODIMENTS

### Overview

Embodiments herein provide computer-implemented techniques for establishing communications between two applications. A client application executing in the foreground on a computing device establishes temporary background communication with a service application by requesting the operating system of the computing device open a uniform resource locator (“URL”) scheme corresponding to the service application. The requested URL includes a named pasteboard established by the client application. When the service application launches, the service application records the name of the named pasteboard. The named pasteboard is a private data area for sharing data between the client and service applications. The service application establishes a background process for monitoring the named pasteboard and then returns control to the client application. The client and service applications then communicate via the named pasteboard. After launching the second application control is returned to the first application. In certain example embodiments, returning control results in the first application returning to operating in the foreground of the operating system.

Aspects of the example embodiments will be explained in more detail in the following description, read in conjunction with the figures illustrating the program flow.

### Example System Architectures

Turning now to the drawings, in which like numerals represent like (but not necessarily identical) elements throughout the figures, example embodiments are described in detail.

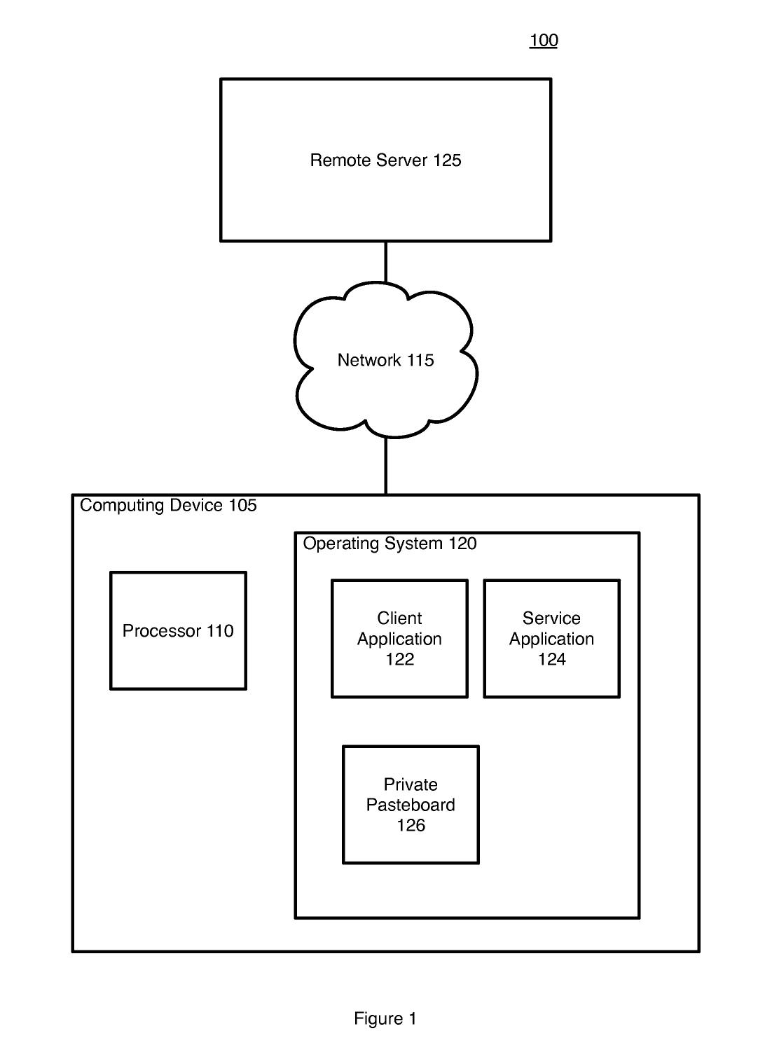

FIG. 1 is a block diagram depicting a system for establishing temporary background communication between two applications. As depicted in FIG. 1, the system 100 includes network devices 105 and 125 that are configured to communicate with one another via one or more networks 115.

Each network 115 includes a wired or wireless telecommunication means by which network devices (including devices 105 and 125) can exchange data. For example, each network 115 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment.

Each network device 105 and 125 includes a device having a communication module capable of transmitting and receiving data over the network 115. For example, each network device 105 and 125 can include a server, desktop computer, laptop computer, tablet computer, a television with one or more processors embedded therein and/or coupled thereto, smart phone, handheld computer, personal digital assistant (“PDA”), or any other wired or wireless, processor-driven device.

It will be appreciated that the network connections shown are example and other means of establishing a communications link between the computers and devices can be used. Moreover, those having ordinary skill in the art having the benefit of the present disclosure will appreciate that the merchant 130, feedback system 140, and the user device 110 illustrated in FIG. 1 can have any of several other suitable computer system configurations. For example a user device 110 embodied as a mobile phone or handheld computer may not include all the components described above.

Computing device 105 comprises a processor 110 and an operating system 120. The operating system comprises a client application 122, a service application 124, and one or more private pasteboards 126. A client application 122 is an application currently executing in the foreground on the computing device 105. A service application 124 is an application that when launched executes primarily in the background and in certain embodiments provides services such as requested data to a client application 122. A pasteboard 126 is a protected data area within the operating system used to share data between the client application 122 and the service application 124. In certain example embodiments, the client 122 and service 124 applications primarily share data by reading and writing to the private pasteboard 126. The terms private and named pasteboard are used interchangeably herein.

### Example Processes

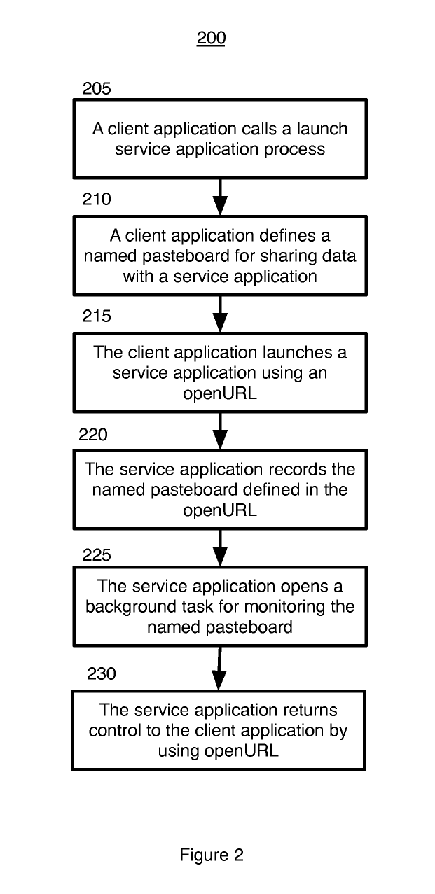

The components of the example operating environment 100 are described hereinafter with reference to the example methods illustrated in FIG. 2.

FIG. 2 is a block flow diagram depicting a method 200 to establish temporary background communication between two applications, in accordance with certain example embodiments.

Method 200 begins at block 205 where a client application (first application) 122 calls a launch service application (second application) method. For example, the client application 122 may be a shopping application on a computing device 105 that needs to verify and present user payment credentials in order to complete an online purchase with a remote merchant server 125. The launch service application method will check to see if the service application 124 is installed by checking to see if a service application URL scheme is supported on the device. For example, in an operating system each application may publish a URL scheme such as application1://[launch process1], application2://[launch process 1]. The URL tells the operating system to launch the application associated with the URL scheme. The named URL for each application can designate a different pre-defined process to execute upon launch of the application so that multiple URLs for an application can define different processes for execution depending on which URL is opened by the operating system. If the service application 124 is installed the method proceeds to block 210. If the service application 124 is not installed the method terminates.

At block 210, the client application 122 defines a named pasteboard 126. In certain example embodiments, the named pasteboard 126 is a temporary pasteboard. The named pasteboard 126 will be shared between the client application 122 and the service application 124. The named pasteboard 126 allows the client application 122 and service application 124 to share data by reading and writing to the named pasteboard 126.

At block 215, the client application requests the operating system to launch the service application 124 by opening the URL for the service application. The requested URL may include the name of a pre-defined named pasteboard 126 to be shared between the client 122 and service 124 applications. Alternatively the client application 122 may include the named pasteboard 126 in the open URL request to the operating system 120. In certain example embodiments, the client application 122 will also include a return URL. The return URL enables the service application 124 to pass control back to the client application 122 after launching by requesting the operating system 120 open the return URL at the end of the service application 124 launch process. In the working example of a shopping application (client application 122) requesting payment credentials to complete an online purchase with a remote merchant server 125, the shopping application may pass a payment credential request from the remote merchant server 125, a return URL for re-launching the client application 122, the name of the named pasteboard 126, and a one time password to encrypt payment credentials to a wallet application (service application 124).

At block 220, the service application 124 launches in response to the operating system 120 opening the corresponding URL, and the service application 124 records the named pasteboard 126 defined by the client application 122 in the URL. In the context of the working example, the wallet application may also verify that the user wallet identifier stored in the wallet application matches the user wallet identifier received in the JWT request from the client application. In certain example embodiments, the service application 124 may launch a user interface to collect information or present execution options to a user of the computing device 105. In the context of the working example, the wallet application (service application 124) may present a “chooser” user interface allowing a user without an electronic wallet account to sign up for an account and add payment credentials, or it may allow an existing user to modify existing account settings such as default payment options.

At block 225, the service application opens a background monitoring task to monitor the named pasteboard 126. In the context of the working example, the wallet application may open a service task to monitor the named pasteboard 126 for a full payment credential request from the shopping application (client application 122). If a full payment request is posted by the client application 122 to the named pasteboard, the wallet application (service application 124) writes the full wallet request to the named pasteboard 126.

In certain example embodiments, the operating system 120 may limit how long a service process can remain open. Accordingly, the service application's 124 background monitoring task will also monitor the amount of time remaining to complete a given background task. For example, the wallet application (service application 124) may post an error message that a full payment request was not received to the named pasteboard 126 within the allotted processing time. In certain example embodiments, the service application 124 may post a request to the named pasteboard 126 for the client application 122 to re-launch the service application 124 if additional processing time beyond an allotted time is needed. The method will then repeat as described above.

At block 230, the service application 124 returns control to the client application by requesting the operating system 120 open the return URL. After the service application 124 returns control to the client application 122, the service application 124 can continue to read and right while to the named pasteboard 126 while the background monitoring task is executing without control being returned to the service application 124. In certain example embodiments, returning control to the client application comprises returning the client application to operating in the foreground of the operating system.

### Other Example Embodiments

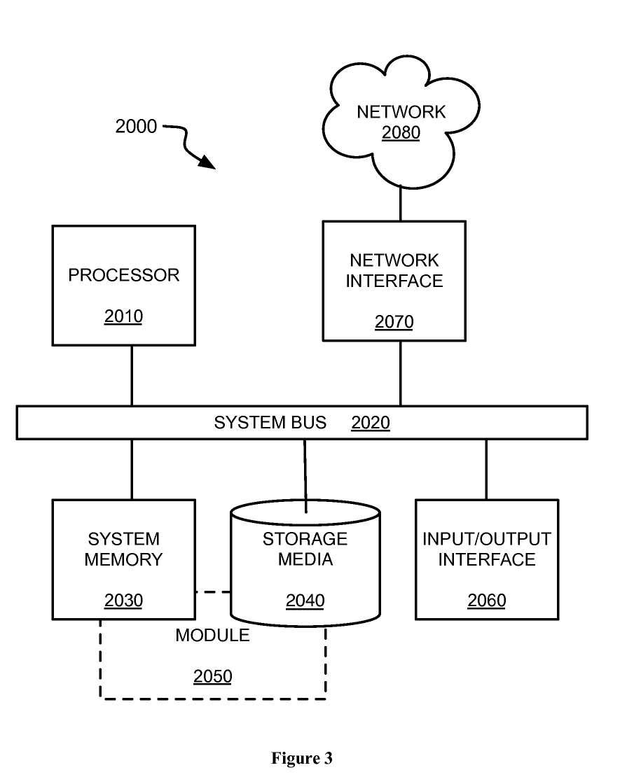

FIG. 3 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act. The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to establish temporary background communication between two applications, the method comprising;
communicating, by a first application executing on a computing device, a request to create a pasteboard to an operating system of the computer device;
communicating, by a first application executing on a computer device, a launch request the launch request comprising a launch URL scheme for launching a second application, a return URL scheme for returning control to the first application, and the name of the created pasteboard;
launching, by the operating system, the second application by opening the launch URL scheme in the launch request received from the first application;
recording, by the launched second application, the name of the pasteboard;
establishing, by the second application, a background monitoring task to monitor the named pasteboard for data requests from the client application;
returning, by the second application, control to the first application;
writing, by the client application, a data request to the named pasteboard;
reading, by the service application, the data request to the named pasteboard; and
writing, by the service application, a response to the data request to the named pasteboard.

2. The method of claim 1, wherein the computing device is a mobile phone computing device.

3. The method of claim 1, wherein the named pasteboard is a temporary pasteboard.

4. The method of claim 1, wherein the operating system returns control to the client application by launching a return URL.

5. The method of claim 4, wherein the return URL is included in the launch request from the client application.

6. The method of claim 1, further comprising terminating, by the service application, the background monitoring process

7. The method of claim 6, wherein the background monitoring service is terminated after a defined time interval has elapsed.

8. The method of claim 1, wherein the second application is an electronic wallet application that writes payment credentials to the name pasteboard for use by the first application to complete an electronic transaction.

9. A computer program product, comprising:
a non-transitory computer-readable medium having computer-readable program instructions embodied thereon, the computer-readable program instructions when executed by a processor cause the processor to establish temporary background communication between two applications, the computer-executable program instructions comprising:
computer-executable program instructions to communicate a launch request to launch a service application to an operating system of the computer device, the request comprising a URL, the URL comprising a named pasteboard defined by the client application and a return URL for returning control to the client application;
computer-executable program instructions to write a data request for the service application to the named pasteboard;
computer-executable program instructions to monitor the named pasteboard for a response to the data request from the service application.

10. The computer program product of claim 9, wherein the named pasteboard is a temporary pasteboard.

11. The computer program product of claim 9, wherein the operating system is a mobile phone device operating system.

12. The computer program product of claim 11, wherein only a single application can operate in the foreground of the mobile phone operating system.

13. The computer program product of claim 11, wherein a return URL is launched after the service application writes a response to the name pasteboard, the return URL returning control to a requesting application.

14. The computer program product of claim 10, wherein a return URL is launched at the end of a defined monitoring time interval to return control to a requesting application.

15. The computer program product of claim 9, further comprising computer-executable program instructions to write a request for payment credentials from a wallet application to the named pasteboard.

16. A system to establish temporary background communication between two applications, comprising:
a storage device; and
a processor communicatively coupled to the storage device, wherein the processor executes application code instructions that are stored in the storage device and that cause the system to;
communicate, by a first application, a launch request to launch a second application to an operating system of the computer device, the request comprising a URL, the URL comprising a named pasteboard defined by the client application;
launch, by the operating system, the second application by opening the URL in the launch request from the first application;
record, by the second application, the location of the named pasteboard;
establish, by the second application, a background monitoring task to monitor the named pasteboard for data requests written to the named pasteboard by the first application;
return, by the operating system, control to the first application.

17. The system of claim 16, wherein only the first application and second application can read and write data to the named pasteboard.

18. The system of claim 16, wherein the named pasteboard is a temporary pasteboard.

19. The system of claim 16, wherein the operating system returns control to the first application by launching a return URL.

20. The system of claim 16, wherein the return URL is included in the launch request from the first application.
